(19) United States
(12) Patent Application Publication
(10) Pub. No.: US 2006/0066549 A1
(43) Pub. Date: Mar. 30, 2006

(54) Flat display apparatus and driving method for flat display apparatus

(75) Inventors: Mizuki Yamada, Kanagawa (JP); Yoshiharu Nakajima, Kanagawa (JP); Hiroaki Ichikawa, Kanagawa (JP); Yoshitoshi Kida, Kanagawa (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Tokyo (JP)

(21) Appl. No.: 11/231,872

(22) Filed: Sep. 22, 2005

(30) Foreign Application Priority Data
Sep. 24, 2004 (JP) P2004-277097
Sep. 24, 2004 (JP) P2004-277108

(51) Int. Cl. G09G 3/36

(52) U.S. Cl. 345/89

(57) ABSTRACT

A flat display apparatus and a driving method therefor are disclosed wherein an image having a pseudo gradation is displayed and peripheral circuits for a driving method based on frame rate control can be formed integrally on an insulating substrate to assure reliable operation. In the flat display apparatus, image data are distributed into a plurality of systems in response to a variation pattern of a gradation of pixels such that variation patterns of the gradations of corresponding pixels in each system are same as each other, and the image data of the systems are outputted. Then, for each system, in response to a logic value of lower order side bit of the image data, a logic value of the signal pattern indicating the variation pattern is added to the high order side bits to modulate the image data of the systems to produce modulation data.

### CROSS REFERENCES TO RELATED APPLICATIONS

The present invention contains subject matter related to Japanese Patent Application P2004-277097 filed in the Japanese Patent Office on Sep. 24, 2004, and Japanese Patent Application P2004-277108 filed in the Japanese Patent Office on Sep. 24, 2004, the entire contents of which being incorporated herein by reference.

### BACKGROUND OF THE INVENTION

This invention relates to a flat display apparatus and a driving method for a flat display apparatus, and more particularly to a flat display apparatus and a driving method for a flat display apparatus which can be applied suitably, for example, to a liquid crystal display apparatus.

Conventionally, a method for driving a liquid crystal display apparatus to display an image of high gradations by frame rate control (FRC) is disclosed, for example, in Japanese Patent No. 2804686.

The frame rate control is illustrated in FIG. 13. Referring to FIG. 13, the gradation of a pixel is changed over in a unit of a frame between a 2n gradation and a 2(n+1) gradation to represent an intermediate 2n+1 gradation between the 2n gradation and 2(n+1) gradation making use of an integration effect in the time axis direction depending upon the characteristic of the eyesight of the human being to display an image of high gradations using a liquid crystal display panel having a small number of gradations. According to the frame rate control, while the gradation is changed over in a unit of a frame in this manner, different variation patterns of the gradation are applied among pixels which are contiguous to each other in the vertical direction and the horizontal direction so as to represent such an intermediate 2n+1 gradation as described above also by an integration effect in the spatial direction as seen in FIG. 14 shown in contrast to FIG. 13 thereby to prevent appearance of flickering making use of the integration effect in the spatial direction depending upon the characteristic of the eyesight of the human being. It is to be noted that, in the following description, an intermediate gradation produced by the integration effect on the eyesight by driving by the frame rate control in this manner is referred to as pseudo gradation, and a gradation set to each pixel for indicating such a pseudo gradation as just mentioned is referred to as true gradation.

Driving of a liquid crystal display panel by the frame rate control is performed in such a manner as seen in FIG. 15 shown in contrast with FIG. 14. In particular, referring to FIG. 15, while the polarity of an applied voltage to each pixel is changed over, such changeover of the gradation as described above is executed for each two frames. It is considered that the voltage application to the liquid crystal can be prevented from being rendered asymmetrically by the execution of the changeover of the gradation. It is to be noted that the polarity is indicated by the signs + and − in FIG. 15.

Thus, in a conventional liquid crystal display apparatus which uses the frame rate control, image data of a display object are inputted to a peripheral circuit, by which high order side bits of the image data are modulated in accordance with the value of low order bits of the image data. Then, the liquid crystal display panel is driven with the image data of the higher order side bits.

Incidentally, in recent years, an ordinary liquid crystal display apparatus is configured such that driving circuits such as a horizontal driving circuit and a vertical driving circuit are formed integrally on an insulating substrate on which pixels are disposed in a matrix so that the liquid crystal display apparatus has a simplified general configuration and has a reduced size and a narrowed frame. It is to be noted that, in conventional liquid crystal display apparatus, a glass substrate is applied as such an insulating substrate as mentioned above. Therefore, also in a display apparatus which uses the frame rate control, it is desired to form the peripheral circuit unique to the frame rate control integrally on the insulating substrate together with the horizontal driving circuit and so forth.

However, where the peripheral circuit unique to the frame rate control is formed integrally on the insulating substrate, semiconductor elements are formed from low temperature polycrystalline silicon TFTs (Thin Film Transistors), CGS (Continuous Grain Silicon) elements or the like. Those semiconductor elements are disadvantageous in that they are low in operation speed and have a great dispersion in operation speed when compared with semiconductor elements formed from silicon.

In contrast, since the frame rate control requires modulation of high order side bits with the value of low order bits of image data as described hereinabove, as the resolution of the display panel is raised, it is necessary to process image data at a higher speed.

From such situations as described above, a flat display apparatus which uses the frame rate control has a problem that reliable operation cannot be assured if a peripheral circuit unit to the frame rate control is merely formed integrally an insulating substrate.

### SUMMARY OF THE INVENTION

It is desirable to provide a flat display apparatus and a driving method for a flat display apparatus wherein peripheral circuits for a driving method based on frame rate control can be formed integrally on an insulating substrate to assure reliable operation.

In order to attain the desire described above, according to an embodiment of the present invention, there is provided a flat display apparatus for displaying an image having a pseudo gradation by varying the gradation of each pixel with a variation pattern different from that of an adjacent pixel in a unit of a frame. The flat display includes: a display section having a plurality of pixels disposed in a matrix thereon; a vertical driving circuit for successively selecting the pixels of the display section in a unit of a line; a horizontal driving circuit for outputting a driving signal to the pixels of the display section in response to the selection of the pixels by the vertical driving circuit; and a data processing circuit for processing image data and outputting resulting data to the horizontal driving circuit. The data processing circuit includes: a serial to parallel conversion circuit for distributing the image data into a plurality of systems in response to the variation pattern of the gradation of the pixels such that the variation patterns of the gradations of the corresponding pixels in each system may be the same and outputting the image data of the systems; a signal pattern generation circuit for generating a signal pattern representative of the variation pattern for each of the systems; and a modulation circuit for adding, for each of the systems, in response to a logic value of a lower order side bit or bits of the image data relating to the display of the pseudo gradation, a logic value of the corresponding signal pattern to high order side bits and outputting the image data of each of the systems to the horizontal driving circuit.

In the flat display apparatus, it is only necessary for the signal pattern generation circuit to generate a signal pattern such that the logic value is changed over for each line. Consequently, even where the delay time is long and/or the dispersion of the delay time is great, a signal pattern can be generated with certainty. Consequently, peripheral circuits for a driving method based on the frame rate control can be formed integrally on an insulating substrate to assure reliable operation.

According to another embodiment of the present invention, there is provided a driving method for a flat display apparatus wherein high order side bits of image data are modulated in response to a low order side bit or bits of the image data to produce modulation data and a plurality of pixels disposed in a matrix are driven with the modulation data such that an image having a pseudo gradation is displayed by varying the gradation of each of the pixels with a variation pattern different from that of an adjacent one of the pixels in a unit of a frame. The driving method includes the steps of: distributing the image data into a plurality of systems in response to the variation pattern of the gradation of the pixels such that the variation patterns of the gradations of the corresponding pixels in each system may be the same and outputting the image data of the systems; and adding, for each of the systems, in response to a logic value of the lower order side bit or bits of the image data, a logic value of the signal pattern indicating the variation pattern to the high order side bits to modulate the image data of the systems to produce the modulation data.

With the driving method for a flat display apparatus, the flat display apparatus can be driven in such a manner that peripheral circuits for the driving method based on the frame rate control can be formed integrally on the insulating substrate to assure reliable operation.

According to a further embodiment of the present invention, there is provided a flat display apparatus for displaying an image having a pseudo gradation by varying the gradation of each pixel with a variation pattern different from that of an adjacent pixel in a unit of a frame. The flat display apparatus includes: a display section having a plurality of pixels disposed in a matrix thereon; a vertical driving circuit for successively selecting the pixels of the display section in a unit of a line; a horizontal driving circuit for outputting a driving signal to the display section in response to the selection of the pixels by the vertical driving circuit; and a data processing circuit for processing image data and outputting resulting data to the horizontal driving circuit. The data processing circuit includes: a signal pattern generation circuit for generating a signal pattern representative of the variation pattern; and a modulation circuit for adding, in response to a logic value of a lower order side bit or bits of the image data relating to display of the pseudo gradation, a logic value of the corresponding signal pattern to high order side bits of the image data and outputting the image data to the horizontal driving circuit. The modulation circuit includes: a low order side addition circuit for adding, to P low order side bits of the high order side bits, a logic value of the corresponding signal pattern in response to a logic value of the low order side bit or bits relating to the display of the pseudo gradation; a high order side addition circuit for calculating a result of addition of Q high order side bits of the high order side bits except the P lower order side bits when a carry appears at the highest order bit of the low order side addition circuit; and a selection circuit for selectively outputting the result of addition by the high order side addition circuit or the Q high order side bits in response to the carry. The modulation circuit outputs the image data which depend upon the addition result by the low order side addition circuit and the result of the selection of the selection circuit to the horizontal driving circuit.

In the flat display apparatus, the high order side bits of image data which are an object of addition of the signal pattern are divided into Q high order side bits and P low order side bits, which can be processed simultaneously and parallelly. Consequently, even where the delay time is long and/or the dispersion of the delay time is great, the image data can be modulated and processed with certainty. Consequently, peripheral circuits for a driving method based on the frame rate control can be formed integrally on an insulating substrate to assure reliable operation.

In summary, with the flat display apparatus and the driving method for a flat display apparatus, peripheral circuits for the driving method based on the frame rate control can be formed integrally on an insulating substrate to assure reliable operation.

The above and other objects, features and advantages of the present invention will become apparent from the following description and the appended claims, taken in conjunction with the accompanying drawings in which like parts or elements denoted by like reference symbols.

### BRIEF DESCRIPTION OF THE DRAWINGS

FIG. 1 is a block diagram showing a liquid crystal display apparatus to which the present invention is applied;

FIG. 2 is a block diagram showing a data processing circuit of the liquid crystal processing apparatus of FIG. 1;

FIG. 3 is a block diagram showing an frame rate control processing circuit of the data processing circuit of FIG. 2;

FIGS. 4A to 4D are time charts illustrating a process where image data are not selectively distributed;

FIGS. 5A to 5D are time charts illustrating operation of a serial to parallel conversion circuit of the data processing circuit of FIG. 2;

FIGS. 6A and 6B are time charts illustrating changeover of the logic value of a signal pattern;

FIG. 7 is a block diagram showing a signal pattern generation circuit of the frame rate control processing circuit of FIG. 3;

FIGS. 8A to 8C are time charts illustrating operation of the signal pattern generation circuit of FIG. 7;

FIGS. 9A to 9F are time charts illustrating operation of the a modulation circuit of the frame rate control processing circuit of FIG. 3;

FIG. 10 is a connection diagram showing a configuration of part of a horizontal driving circuit;

FIGS. 11A to 11D are time charts illustrating changeover of the polarity of a reference voltage;

FIGS. 12A to 12D4 are time charts illustrating driving of pixels;

FIG. 13 is a flow diagram illustrating frame rate control;

FIG. 14 is a flow diagram illustrating a relationship of adjacent pixels in the frame rate control; and

FIG. 15 is a flow diagram illustrating changeover of the polarity among applied voltages to pixels.

### DETAILED DESCRIPTION OF THE PREFERRED EMBODIMENT

### 1. Configuration of the Embodiment

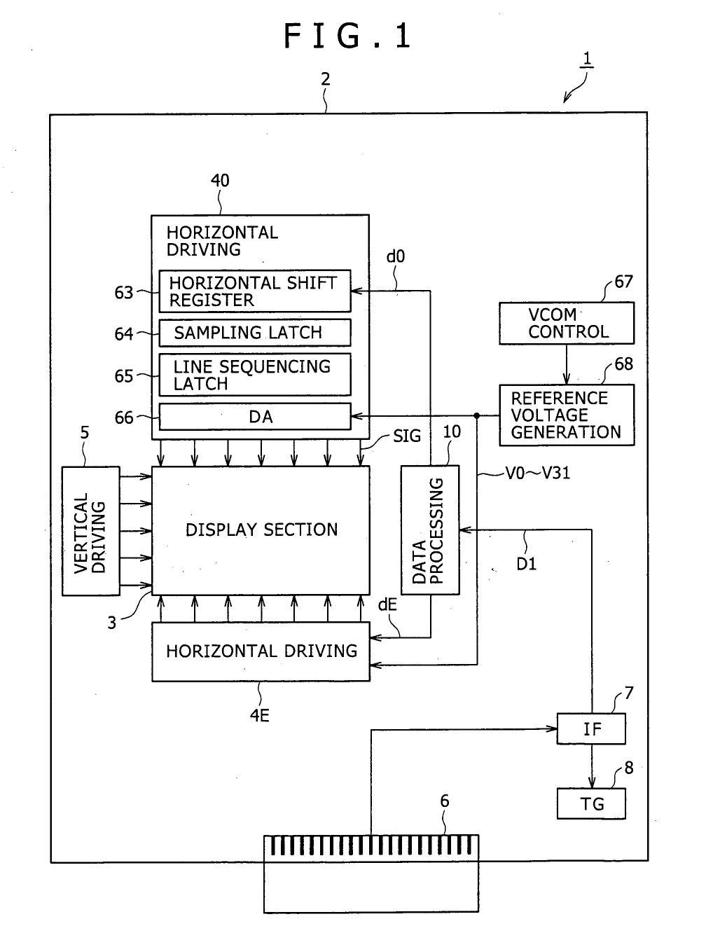

FIG. 1 shows a flat display apparatus in the form of a liquid crystal display apparatus to which the present invention is applied. Referring to FIG. 1, the liquid crystal display apparatus 1 shown includes an insulating substrate which forms a display section 3, and peripheral circuits of the display section 3 formed integrally on the insulating substrate such that it displays an image of high gradations by a driving method of the frame rate control. Thus, in the liquid crystal display apparatus 1, semiconductor elements such as a horizontal driving circuit are formed from TFTs, CGS elements or the like.

In particular, the liquid crystal display apparatus 1 includes a glass substrate 2 which forms the insulating substrate described above and liquid crystal pixels disposed in a matrix on the glass substrate 2 to form the display section 3. The display section 3 is driven by a pair of horizontal driving circuits 4O and 4E disposed above and below the display section 3 and a vertical driving circuit 5 disposed sidewardly of the display section 3 to display a color image. The display section 3 includes color filters of red, green and blue disposed successively and cyclically, for example, in the horizontal direction for the individual pixels. For the liquid crystal display apparatus 1, image data D1 to be used to display are produced which include data of the colors of 6 bits disposed corresponding to the arrangement of the color filters in the display section 3 such that the color data are repeated successively and cyclically in a raster scanning order. The image data D1 are inputted from signal input terminals 6 to the liquid crystal display apparatus 1 together with a master clock, a horizontal synchronizing signal, a vertical synchronizing signal and so forth.

An interface (IF) 7 receives various signals inputted from the signal input terminals 6 and outputs the signals to suitable components of the liquid crystal display apparatus 1. A timing generator (TG) 8 produces various operation reference signals necessary for operation of the liquid crystal display apparatus 1 from the master clock, horizontal synchronizing signal, vertical synchronizing signal and so forth inputted through the interface 7 and outputs the produced operation reference signals. The vertical driving circuit 5 operates with the operation reference signal outputted from the timing generator 8 to successively select the pixels of the display section 3 in a unit of a line.

In the liquid crystal display apparatus 1, signal lines for the pixels are driven by the horizontal driving circuits 4O and 4E in response to the selection of the pixels by the vertical driving circuit 5 in a unit of a line to display a desired image. To this end, in the liquid crystal display apparatus 1, the image data D1 inputted from the signal input terminals 6 are processed by a data processing circuit 10 and distributed to the horizontal driving circuits 4O and 4E so that the display section 3 is driven by the horizontal driving circuits 4O and 4E.

FIG. 2 shows the data processing circuit 10. Referring to FIG. 2, the data processing circuit 10 includes a serial to parallel conversion circuit 11 which distributes and outputs, where pixels contiguous in the horizontal direction are to be displayed with the same pseudo gradation, the image data D1 inputted thereto to groups for which true gradations exhibit the same variation pattern.

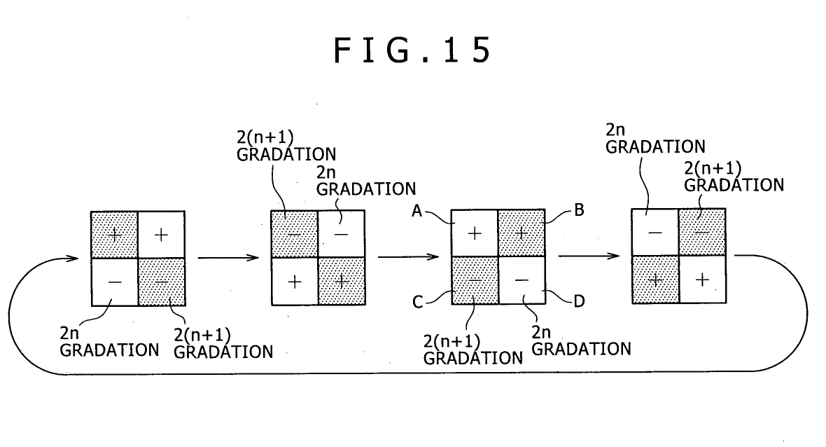

The liquid crystal display apparatus 1 according to the present embodiment is configured such that the lowest order bit D1[0] of the 6-bit image data D1 (D1[5] to D1[0]) is represented by a pseudo gradation such that, as described hereinabove with reference to FIG. 15, the true gradation is made different between pixels contiguous to each other in the horizontal direction. In particular, an odd-numbered pixel A in the horizontal direction displays a 2n gradation in the top two frames among successive four frames and then displays a 2(n+1) gradation in the succeeding two frames. Meanwhile, a succeeding even-numbered pixel B conversely displays the 2(n+1) gradation in the top two frames and displays the 2n gradation in the succeeding two frames. On the other hand, pixels C and D in the succeeding line display the gradations but in the reversed relationship. Consequently, in the present embodiment, image data successively inputted in an order of raster scanning are distributed alternately into a system relating to odd-numbered pixels and another system relating to even-numbered pixels and outputted corresponding to the odd-numbered pixels and the even-numbered pixels.

In particular, the serial to parallel conversion circuit 11 inputs the bits D1[0] to D1[5] of the image data D1 to distribution circuits 12A to 12F, respectively. The distribution circuits 12A to 12F have a same configuration, and level shift the bits D1[0] to D1[5] of the image data D1 to signal levels suitable for processing by the data processing circuit 10 each by means of a level shift circuit 13, respectively. Then, the bits D1[0] to D1[5] of the image data D1 having the shifted level are latched alternately by D-type flip-flop circuits (DFF) 14 and 15. Thus, the serial to parallel conversion circuit 11 distributes the bits D1[0] to D1[5] of the image data D1 into two systems of image data D1O and D1E by means of the distribution circuits 12A to 12F and outputs the two systems of image data D1O and D1E.

Frame rate control (FRC) processing circuits 16O and 16E receive the two systems of image data D1O and D1E from the serial to parallel conversion circuit 11, convert the 6-bit image data D1O and D1E into 5-bit image data S1O and S1E to be used for driving of the frame rate control and outputs the image data S1O and S1E.

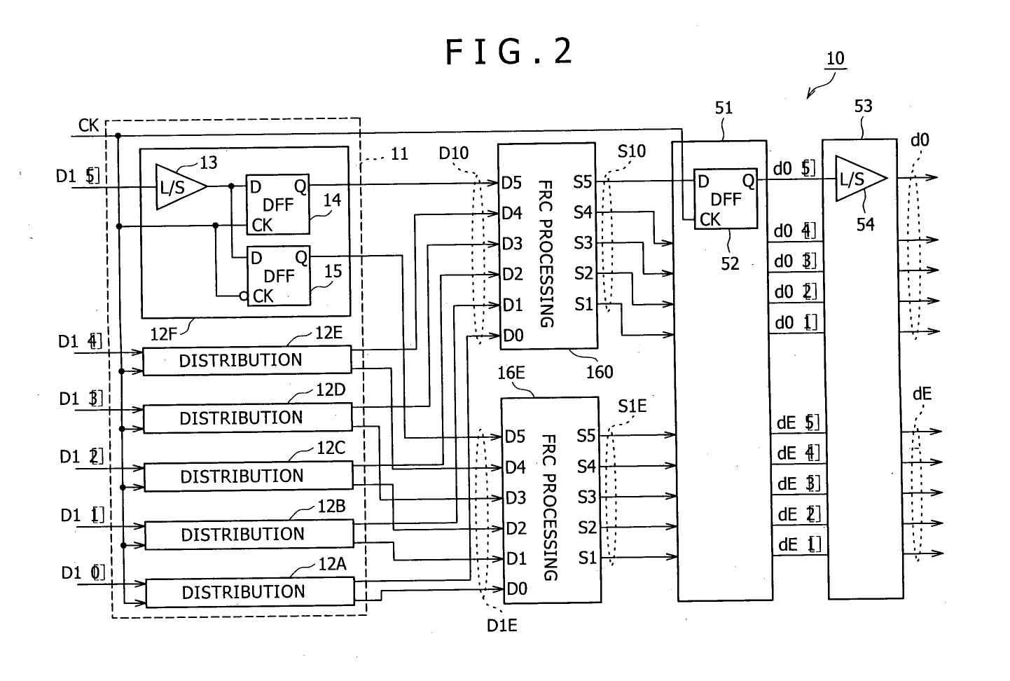

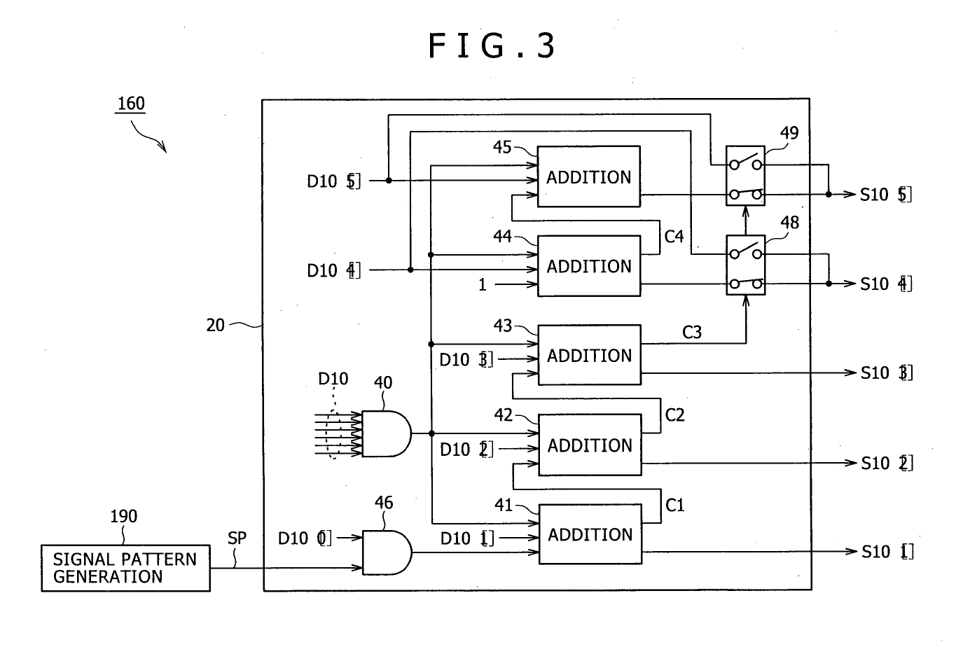

The frame rate control processing circuit 16O is shown in FIG. 3. Referring to FIG. 3, the frame rate control processing circuit 16O includes a signal pattern generation circuit 19O for generating a signal pattern SP representative of a variation pattern of true gradations for display of pseudo gradations. The frame rate control processing circuit 16O further includes a modulation circuit 20 which adds a logic value of the signal pattern SP to the high order bits D1[1] to D1[5] in response to the logic value of the lowest order bit D1O[0] of the image data D1O thereby to modulate the high order bits D1O[0] to D1O[5] of the image data D1O with the signal pattern SP to produce 5-bit image data S1O by driving of the frame rate control.

In the present embodiment, when pseudo gradations are used for display, the image data D1O and D1E are distributed into groups in which the true gradations indicate the same variation pattern and inputted to the frame rate control processing circuits 16O and 16E, by which the image data S1O and S1E to be used for driving of the frame rate control in the signal pattern SP are generated. Consequently, in the signal patterns SP in the frame rate control processing circuits 16O and 16E, it is necessary only to change over the logic values in a unit of a line. Consequently, in the present embodiment, peripheral circuits for the driving system according to the frame rate control can be formed integrally on an insulating substrate to assure reliable operation.

Where true gradations are varied in accordance with variation patterns which are different between pixels contiguous to each other in the horizontal direction as described hereinabove with reference to FIG. 15, it is necessary to vary the signal pattern SP for each bit of the image data D1 (FIG. 4A) inputted in the order of raster scanning (FIG. 4B). However, where the signal patterns are produced by semiconductor elements formed integrally on a glass substrate, delay time T1 appears, and the dispersion of the delay time T1 is great.

Consequently, with image data S1 (FIG. 4C) obtained by processing with such signal patterns SP as described above, where they are sampled and processed with reference to a clock CK (FIG. 4D), a margin in time cannot be assured sufficiently. Consequently, reliable operation cannot be assured.

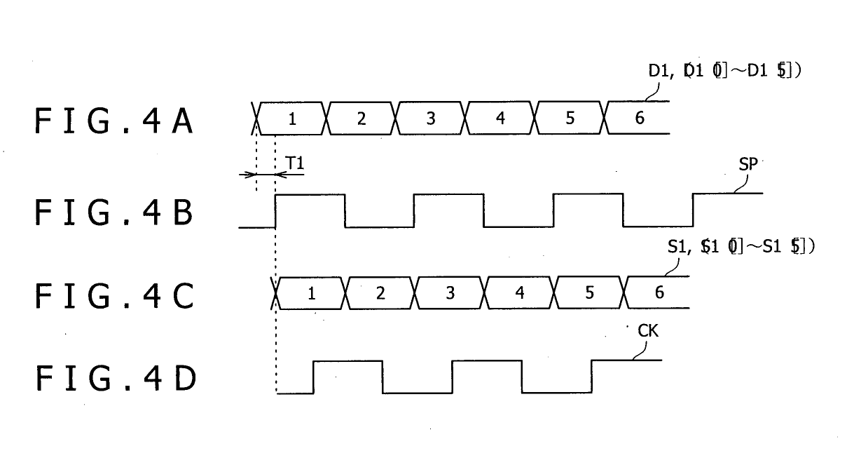

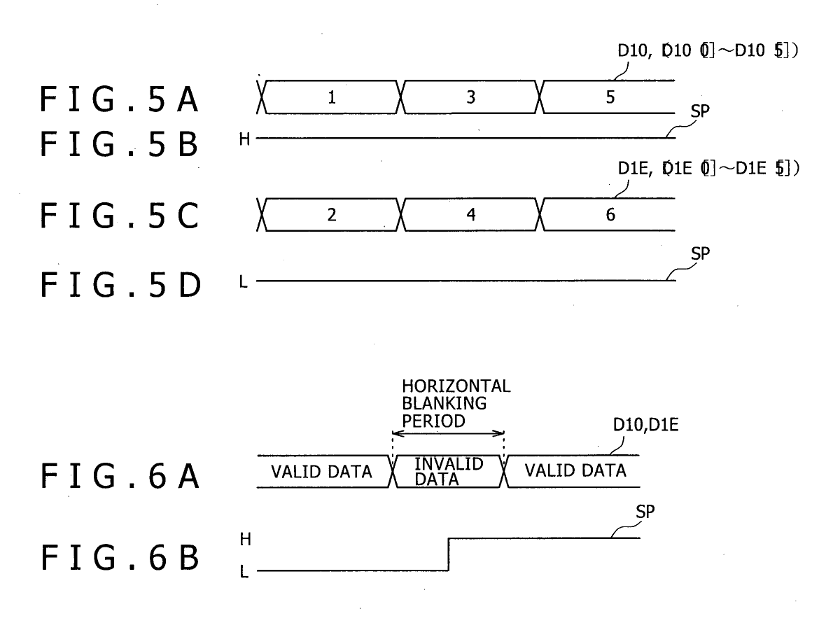

However, as seen from FIGS. 5A to 5D in contrast with FIGS. 4A to 4D, where the image data D1O and D1E obtained by the distribution for the same variation patterns are processed (FIGS. 5A and 5C), only it is necessary to omit changeover of the signal pattern SP for each bit of the image data D1O and D1E in each group and change over the logic value of the signal pattern SP in a unit of a line (FIGS. 5B and 5D). Consequently, a margin in time can be assured as much to assure reliable operation. It is to be noted that such changeover of the logic values in the signal patterns SP can be executed within a horizontal blanking period which has a sufficient margin in time as seen in FIGS. 6A and 6B. Also in this instance, a sufficient margin can be assured.

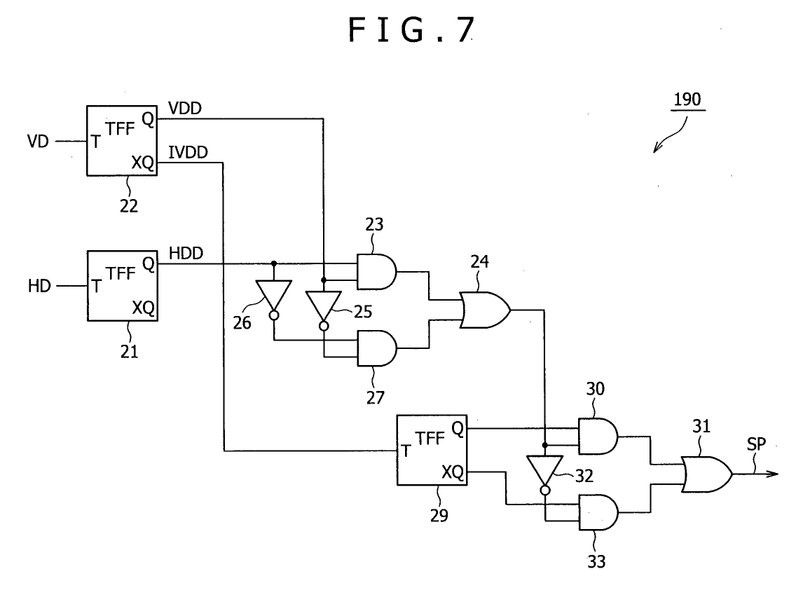

FIG. 7 shows the signal pattern generation circuit 19O of the frame rate control processing circuit 16O. It is to be noted that the frame rate control processing circuit 16E of the other system is configured similarly to the frame rate control processing circuit 16O except that the logic values of the signal patterns SP are different. Therefore, in the following description, only the configuration of the frame rate control processing circuit 16O is described in detail. Referring to FIG. 7, the signal pattern generation circuit 19O includes a pair of T-type flip-flop circuits (TFF) 21 and 22 to which an horizontal synchronizing signal HD and a vertical synchronizing signal VD are inputted, respectively. The T-type flip-flop circuits 21 and 22 use the horizontal synchronizing signal HD and the vertical synchronizing signal VD as respective trigger signals to produce timing signals HDD and VDD, IVDD having a signal level changed over in response to the horizontal synchronizing signal HD and the vertical synchronizing signal VD, respectively. The signal pattern generation circuit 19O gates the timing signal HDD produced with reference to the horizontal synchronizing signal HD and outputted from the T-type flip-flop circuit 21 with the timing signal VDD produced with reference to the vertical synchronizing signal VD and outputted from the T-type flip-flop circuit 22 by means of an AND circuit 23 and outputs the gated timing signal HDD to an OR circuit 24. Meanwhile, inverter circuits 25 and 26 produce inverted signals of the timing signals VDD and HDD produced based on the vertical synchronizing signal VD and the horizontal synchronizing signal HD, respectively, and output the produced inverted signals to the OR circuit 24 through an AND circuit 27. Consequently, the signal pattern generation circuit 19O produces a timing signal, whose signal level is reversed in response to the horizontal synchronizing signal HD and the vertical synchronizing signal VD, by means of the OR circuit 24.

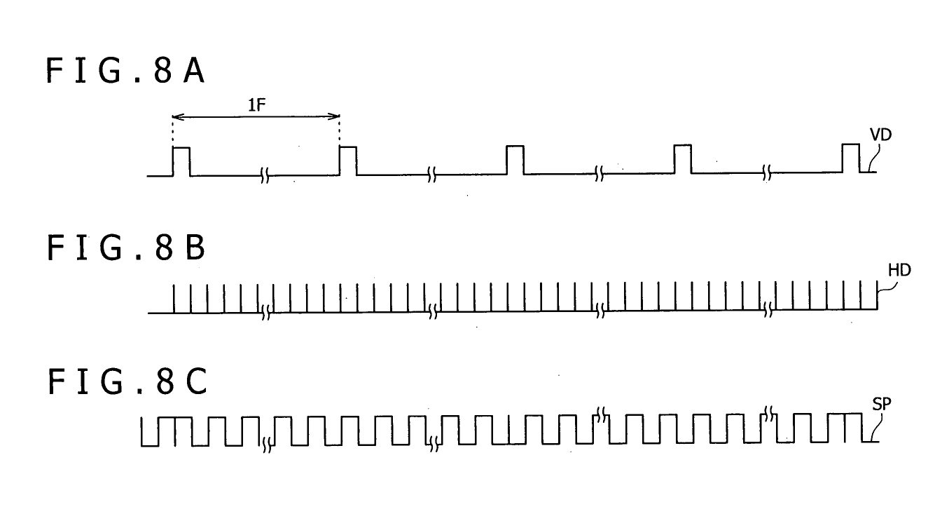

The signal pattern generation circuit 19O inputs an inverted output IVDD of the T-type flip-flop circuit 22 to a T-type flip-flop circuit 29, which produces a timing signal whose signal level changes over in synchronism with the vertical synchronizing signal VD for each two frames. The signal pattern generation circuit 19O gates the output signal of the OR circuit 24 with the output signal of the T-type flip-flop circuit 29 by means of an AND circuit 30 and outputs the gated signal to an OR circuit 31. Further, the signal pattern generation circuit 19O produces an inverted signal from the output signal of the OR circuit 24 by means of an inverter circuit 32, and gates the inverted signal with an inverted output signal of the T-type flip-flop circuit 29 by means of an AND circuit 33 and outputs the gated signal to the OR circuit 31. Consequently, the signal pattern generation circuit 19O produces a signal pattern SP wherein, as seen in FIGS. 8a to 8c, in two top frames from among successive four frames, the logic value has a high value in odd-numbered lines but has a low value in even-numbered lines, but in the two succeeding lines, the logic value has a high level in odd-numbered lines and has a low level in even-numbered lines

In contrast, the frame rate control processing circuit 16E produces signal patterns wherein the logic value is reversed from that in the signal pattern SP produced by the signal pattern generation circuit 19O.

However, if the lowest order bit D1O[0] of the image data D1O has the logic value 1, then the modulation circuit 20 (FIG. 3) adds the logic value of the signal pattern SP to the high order bits D1[1] to D1[5] thereby to modulate the high order bits D1O[1] to D1O[5] of the image data D1O with the signal pattern SP to produce image data S1O to be used for driving of the frame rate control.

In particular, in the modulation circuit 20 shown in FIG. 3, an AND circuit 40 receives the bits D1O[0] to D1O[5] of the image data D1O as inputs thereto and outputs a control signal for instruction of execution of an arithmetic operation to addition circuits 41 to 45 when all of the bits of the image data D1O have values other than the logic value 0. An AND circuit 46 gates the signal pattern SP with the lowest order bit D1O[0] of the image data D1O so that, only when the lowest order bit D1O[0] has the logic value 1, the logic value of the signal pattern SP is outputted to the addition circuit 41.

The addition circuits 41 to 45 are allocated to the high order bits D1O[1] to D1O[5], respectively, of the image data D1O except the lowest order bit D1O[0] and output, when the control signal outputted from the AND circuit 40 has a high level, output values S1O (S1O[1] to S1O[5]) of the logic value 1. Of the addition circuits 41 to 45, the addition circuits 41 to 43 for the low order side 3 bits add the logic value of the signal pattern SP to the low order side 3 bits D1O[1] to D1O[3] of the image data D1O in response to a rising edge of the control signal outputted from the AND circuit 46 and output addition results S1O[1] to S1O[3], respectively. In particular, the addition circuit 41 of the lowest order bit D1O[1] of the side 3 bits D1O[1] to D1O[3] outputs one bit SiO[1] and a carry C1 as a result of the addition of the lowest order bit D1O[1] and the signal pattern SP. The next addition circuit 42 adds a corresponding one bit DiO[2] of the image data D1O and the carry C1 from the addition circuit 41 and outputs one bit SiO[2] and a carry C2 as a result of the addition. Further, the next addition circuit 43 adds a corresponding one bit D1O[3] of the image data D1O and the carry C2 from the addition circuit 42 and outputs one bit S1O[3] and a carry C3 as a result of the addition.

On the other hand, the addition circuits 44 and 45 for the high order side 2 bits D1O[4] and D1O[5] calculate a result of addition when the carry c3 is generated by the addition circuit 43 for the highest order on the lower order side and outputs the addition result. In particular, the addition circuit 44 on the lower order side from between the addition circuits 44 and 45 adds the logic value 1 to a corresponding one bit D1O[4] of the image data D1O and outputs one bit and a carry C4 of a result of the addition. The following addition circuit 45 adds a corresponding one bit D1O[5] of the image data D1O and the carry C4 from the addition circuit 44 and outputs one bit of a result of the addition.

The modulation circuit 20 selects 2 bits of a result of the addition by the addition circuits 44 and 45 where the carry C3 is generated from the lower order side and 2 bits inputted to the addition circuits 44 and 45 where the carry C3 is not generated from the lower order side in response to the logic value of the carry C3 by means of selection circuits 48 and 49. The modulation circuit 20 outputs the selected 2 bits as an addition result S1O[4] and S1O[5] of the higher order side 2 bits.

In short, the modulation circuit 20 performs, in an addition process by an n-bit addition circuit, addition of high order side predetermined bits only on the high order side to determine and prepare an addition value when a carry is generated from the low order side and outputs the addition value or the high order side bits for which no such addition process has been performed in response to the carry of the low order side thereby to allow the peripheral circuits for the driving method by the frame rate control to be formed integrally on the insulating substrate and assure reliable operation. Further, where the bit number of the high order side bits used for the calculation performed in advance in this manner is set smaller than the number of the bits of the low order side, a result of addition of all bits can be outputted with certainty upon completion of the addition process of the low order side bits.

In particular, where the logic value of the signal pattern SP of the lowermost bit of the image data of predetermined bits is used for the addition process in this manner, since it is necessary to process a carry from the low order side bits for the high order side bits, the addition process is performed after the process of the low order side bits is performed. Consequently, the higher the order, the longer the delay time and the greater the dispersion of the delay time. Consequently, in such a case that the addition result is sampled and processed with reference to the clock CK or in a like case, the margin in time cannot be assured sufficiently, and consequently, reliable operation cannot be assured.

However, if an addition result when a carry is generated is calculated and prepared on high order side bits simultaneously and concurrently with an addition process of low order side bits and the prepared value or the high order side bits for which the addition process has not been performed are selectively outputted in response to the carry of the low order side, then generation of the delay time of the high order side bits prepared in advance from the low order side bits can be set almost to zero. Consequently, the peripheral circuits for the driving method based on the frame rate control can be formed integrally on the insulating substrate to assure reliable operation.

Further, particularly if the bit number of the high order bits used for the calculation performed in advance in this manner is set to a bit number smaller than the number of bits of the low order side, then an addition result of all bits can be outputted with certainty. Consequently, the peripheral circuits for the driving method based on the frame rate control can be formed integrally on the insulating substrate to assure reliable operation.

By the processes described above, the frame rate control processing circuits 16O and 16E convert the 6-bit image data D1O and D1E into 5-bit image data S1O and S1E for frame rate control driving and outputs the 5-bit image data S1O and S1E (FIG. 2). A phase adjustment circuit 51 adjusts the phase of the image data S1O and S1E outputted from the frame rate control processing circuits 16O and 16E and outputs the image data S1O and S1E of the adjusted phase.

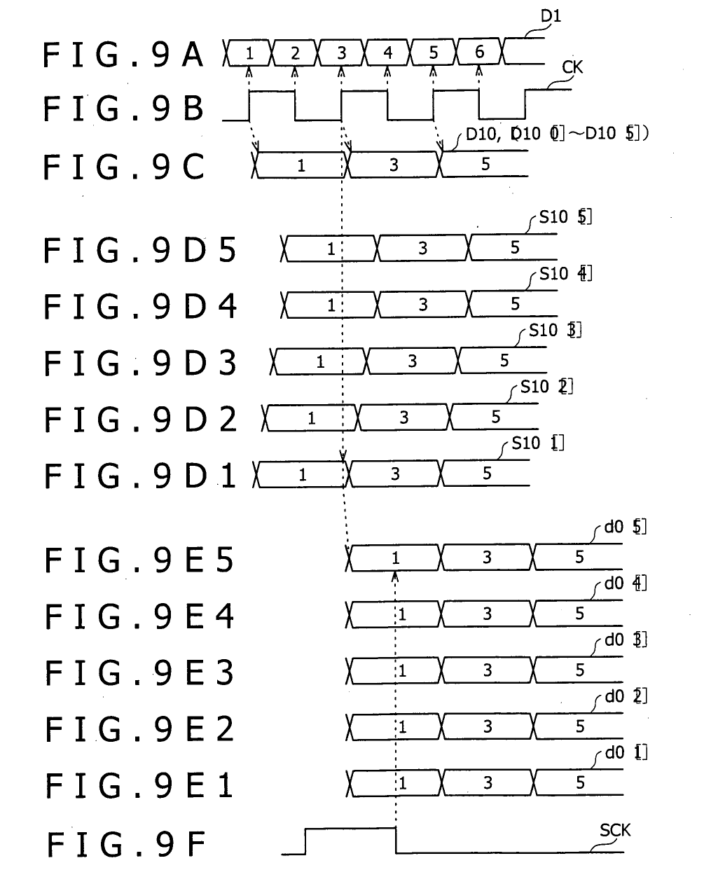

In particular, referring to FIGS. 9A to 9F, where the image data D1 (FIG. 9A) inputted successively are to be distributed into two systems in response to the clock CK (FIG. 9B) and the image data D1O (FIG. 9C) of one of the two systems are processed by the frame rate control processing circuit 16O, the addition results S1O[1] to S1O[5] (FIGS. 9D1 to 9D5) according to a result of the processing are successively delayed and outputted. Consequently, where the addition results are processed, the sampling margin decreases.

Therefore, the phase adjustment circuit 51 receives bit outputs of the image data S1O and S1E at D-type flip-flop circuits 52 thereof such that the bit outputs are latched and outputted in response to the clock CK by and from the D-type flip-flop circuits 52 (FIGS. 9E1 to 9E5). Consequently, in the present embodiment, where a sampling clock SCK is used for sampling and processing (FIG. 9f), the margins for the bits are set so as to be equal to each other. Also by this, it is possible to form the peripheral circuits for the driving method based on the frame rate control integrally on the insulating substrate to assure reliable operation.

The data processing circuit 10 inputs the bit outputs having the phases adjusted in this manner to a level adjustment circuit 53, by and from which the bit outputs are level-shifted and outputted by means of level shift circuits 54.

Referring back to FIG. 2, the horizontal driving circuits 4O and 4E are connected to the display section 3 such that they output driving signals to the pixels of odd-numbered columns and the pixels of even-numbered columns from among the pixels contiguous to each other in the horizontal direction of the display section 3, respectively. Consequently, the horizontal driving circuits 4O and 4E receive image data dO and dE of the odd-numbered columns and the even-numbered columns from the data processing circuit 10, respectively, to produce a driving signal. It is to be noted that the horizontal driving circuits 4O and 4E are configured similarly to each other except that image data of a processing object and the output object of the driving signal are different. Therefore, in the following description, the configuration only of the horizontal driving circuit 4O is described, but overlapping description of the horizontal driving circuit 4E is omitted herein to avoid redundancy.

Referring to FIG. 1, in the horizontal driving circuit 4O, while the sampling clock SCK for sampling the image data dO is successively transferred by a horizontal shift register 63, the image data dO are successively latched by a sampling latch circuit 64 with the sampling clock SCK being transferred by the horizontal shift register 63 and then transferred to a line sequencing latch circuit 65. Consequently, the horizontal driving circuit 4O fetches the image data dO which are successively contiguous to each other in the order of raster scanning in a unit of a line.

A digital to analog conversion circuit (DA) 66 selects reference voltages V0 to V31, which are used to change over the polarity under the control of a VCOM control circuit 67, based on the image data fetched by the line sequencing latch circuit 65 and produces and outputs a driving signal for each signal line.

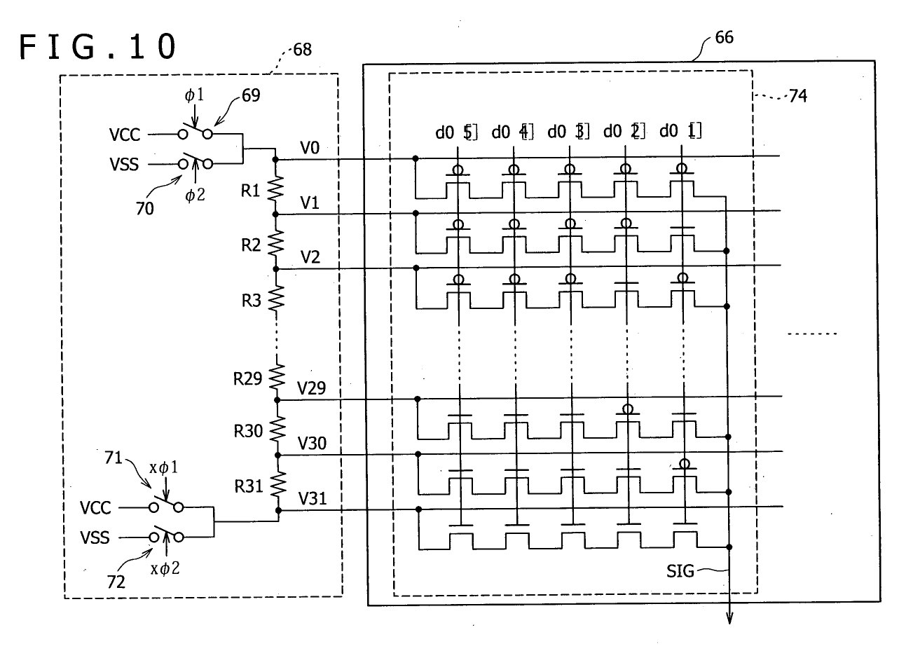

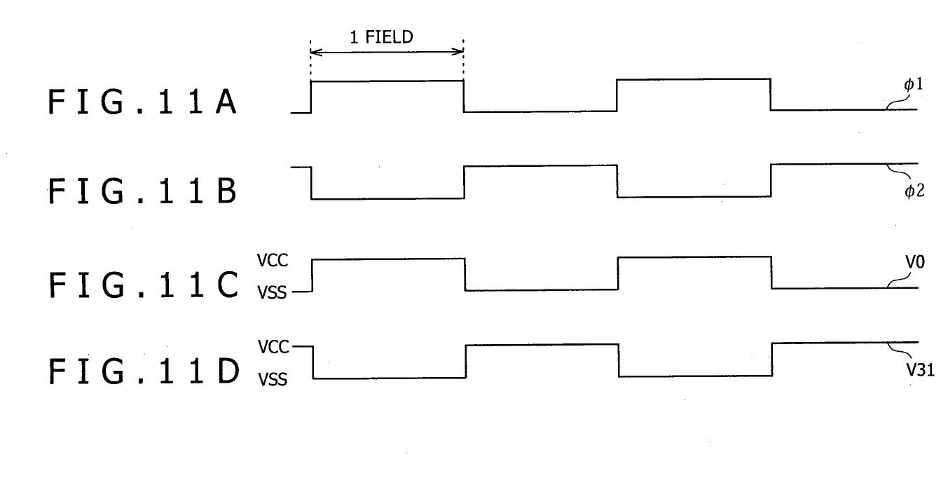

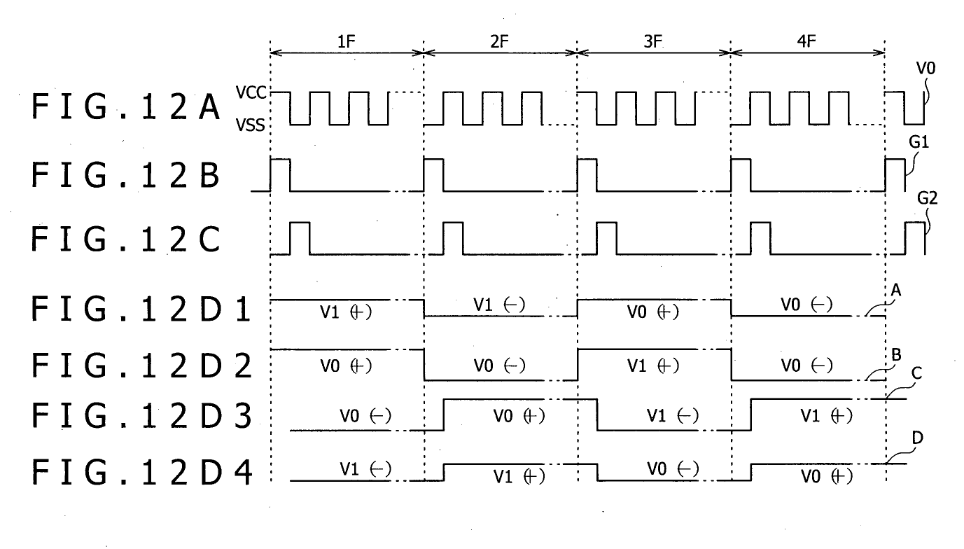

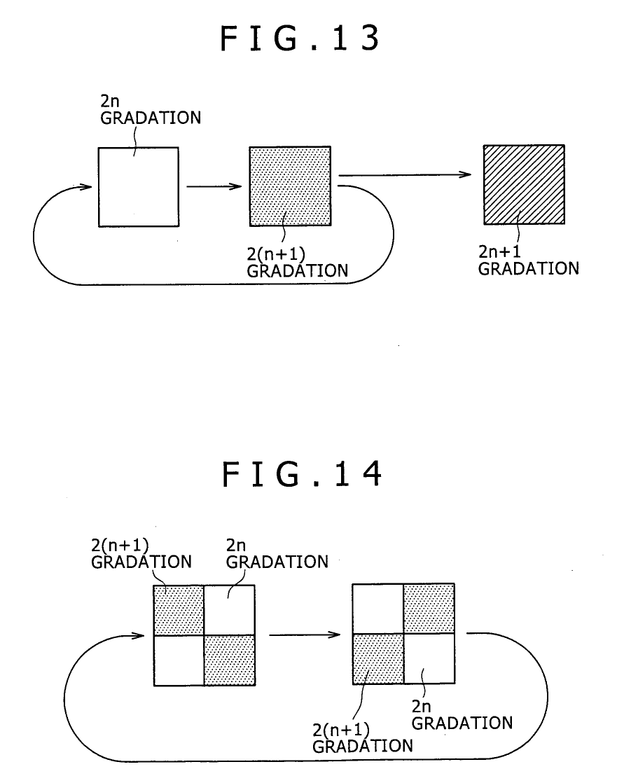

In particular, referring to FIG. 10, a reference voltage generation circuit 68 includes a series circuit formed from resistors R1 to R31 connected in series for dividing an original reference voltage to generate a plurality of reference voltages V0 to V31. The reference voltage generation circuit 68 further includes switch circuits 69 to 72 whose operation is changed over in response to control signals φ1 and φ2 and inverted signals xφ1 and xφ2 of the control signals φ1 and φ2 outputted from the VCOM control circuit 67 as seen in FIGS. 11A to 11D. The switch circuits 69 to 72 thereby change over the polarity of the original reference voltage to be divided by the series circuit for each line.

Referring back to FIG. 10, the digital to analog conversion circuit 66 includes a plurality of digital to analog conversion sections 74 corresponding to signal lines SIG used to drive the horizontal driving circuit 40 and inputs the image data dO (dO[1] to dO[5]) fetched into the line sequencing latch circuit 65 individually to the digital to analog conversion sections 74. Each of the digital to analog conversion sections 74 selects one of the reference voltages V0 to V31 outputted from the reference voltage generation circuit 68 in response to the logic value of the image data dO (dO[1] to dO[5]) by means of a switch circuit formed from a series circuit of TFTs and outputs the selected reference voltage.

The horizontal driving circuit 40 having the configuration described above changes over the polarity of a reference voltage in a unit of a line (FIG. 12(A)) such that the gradation of each pixel is changed over with a pattern different from that of an adjacent pixel in a period of four frames as seen in FIG. 12A. FIGS. 12D1 to 12D4 illustrates variations of the applied voltage to pixels A to D where 2×2 pixels contiguous in the horizontal direction and the vertical direction and denoted by reference characters A to D in FIG. 15 are displayed in two gradations. Meanwhile, FIGS. 12B and 12C illustrate gate signals G1 and G2 from the vertical driving circuit 5 which indicates selection of pixels of each line for such 2×2 pixels.

### 2. Operation of the Embodiment

Referring to FIG. 1, the liquid crystal display apparatus 1 having the configuration described above receives image data D1, formed from repetitions of color data of red, green and blue, successively in an order of raster scanning. The image data D1 are inputted to the data processing circuit 10 through the interface 7 and distributed to the horizontal driving circuits 4O and 4E by the data processing circuit 10. In the liquid crystal display apparatus 1, the horizontal driving circuits 4O and 4E generate driving signals for the signal lines of the display section 3 based on the image data dO and dE inputted to the horizontal driving circuits 4O and 4E in this manner. The pixels of the display section 3 which are selected in a unit of a line by the vertical driving circuit 5 are driven by the driving signals so that a color image is displayed on the display section 3.

In the liquid crystal display apparatus 1, each of the pixels driven in this manner is driven such that the gradation thereof varies in a variation pattern different from that of an adjacent pixel in a unit of a frame so that a pseudo gradation is displayed by frame rate control driving.

In the liquid crystal display apparatus 1, in accordance with the driving according to the frame rate control, the serial to parallel conversion circuit 11 of the data processing circuit 10 distributes the image data D1 successively inputted thereto into a plurality of systems in response to the variation patterns of the corresponding pixels such that the same variation pattern may be applied to each of the systems. In the present embodiment, the lowest order bit D[0] of the 6-bit image data D1 is displayed in a pseudo gradation, and the image data D1 are distributed to the two systems of image data D1O and D1E. In the variation pattern of each of the systems of the image data D1 distributed in this manner, the logic value is changed over in a unit of a line.

In the liquid crystal display apparatus 1, the systems of the image data D1O and D1E are inputted to the frame rate control processing circuits 16O and 16E, in which signal patterns SP representative of the variations of the systems are produced by the signal pattern generation circuits 19O and 19E (FIG. 3), respectively. Each of the signal patterns SP may be formed such that the logic value is changed over in a unit of a line in accordance with the variation pattern. Consequently, in the present embodiment, a sufficient margin in time can be provided to appearance of delay time and a dispersion in delay time relating to the signal pattern SP. Consequently, in the liquid crystal display apparatus 1, the peripheral circuits for the driving method based on the frame rate control can be formed integrally on the insulating substrate to assure reliable operation.

Each of the signal patterns SP is gated with the lowest order bit of the image data D1O or D1E relating to display of pseudo gradations by the AND circuit 46 and outputted to the addition circuit 41. Consequently, the corresponding logic value of the signal pattern SP is added to the high order side bits of the image data D1O or D1E in response to the logic value of the low order side bits relating to the display of pseudo gradations to produce image data S1O or S1E of the system. However, since, in the addition process by such pseudo gradation processing as described above, it is necessary to process a carry generated from the low order side bits with the high order side bits, appearance of delay time cannot be avoided. Thus, where semiconductor elements are formed on a glass substrate as in the case of the present embodiment, the delay time is long and disperses, and a sufficient margin in time cannot be assured in later processing.

Therefore, in the present embodiment, the image data S1O and S1E obtained by the addition process are adjusted in phase with each other by the phase adjustment circuit 51 and inputted as the image data dO and dE to the horizontal driving circuits 4O and 4E, respectively. Consequently, in the present embodiment, a sufficient margin in time can be assured in the processing of the horizontal driving circuits 4O and 4E, and as a result, the peripheral circuits for the driving method based on the frame rate control can be formed integrally on the insulating substrate to assure reliable operation.

Further, as regards the delay time by the addition process, since it is necessary to process a carry generated on the low order side bits with the high order side bits as described hereinabove, longer delay time is required for and the delay time disperses more with regard to a higher bit. Also this makes it difficult to assure a sufficient margin in time. In this instance, sufficient time cannot be used for the addition process on the high order side bits.

Therefore, in the present embodiment, the modulation circuit 20 adds, in response to the logic value of the low order side bits relating to the display of pseudo gradations, the logic value of the corresponding signal pattern SP to the high order side bits to modulate the image data, and the addition circuits 41 to 43 on the low order side add the logic value of the corresponding signal pattern SP to lower order side P bits of the high order side bits in response to the logic value of the low order side bits relating to the display of pseudo gradations. Further, the addition circuits 44 and 45 on the high order side calculate addition results regarding the high order side Q bits other than the low order side P bits of the high order side bits when the carry C3 is generated at the highest order bit of the addition circuits 41 to 43 on the low order side. Then, when the carry C3 appears at the highest order bit actually, the addition results by the addition circuits 44 and 45 are selected and outputted together with the results of addition by the addition circuits 41 to 43 on the low order side. However, when the carry C3 does not appear, the Q bits on the upper side inputted to the addition circuits 44 and 45 on the high order side are selected and outputted together with the addition results by the addition circuits 41 to 43 on the low order side.

Consequently, in the liquid crystal display apparatus 1, the addition processes of the high order side bits Q and the low order side bits P can be executed simultaneously and parallelly to reduce the time required for the addition processes. Therefore, a sufficient margin in time can be assured in the addition process, and the peripheral circuits for the driving method based on the frame rate control can be formed integrally on the insulating substrate to assure reliable operation.

Further, since the high order side bits Q and the low order side bits P are processed separately and the bit number of the high order side bits Q is set to a bit number smaller than that of the low order side bits P, when the carry C3 is actually generated at the highest order bit of the low order side bits Q and the results of addition by the addition circuits 44 and 45 on the high order side are selectively outputted, a result of addition of all bits can be outputted with certainty. Also by this, the peripheral circuits for the driving method based on the frame rate control can be formed integrally on the insulating substrate to assure reliable operation.

The image data dO and dE inputted to the horizontal driving circuits 4O and 4E in this manner are acquired by the sampling latch circuit 64 and the line sequencing latch circuit 65 in a unit of a line in response to the sampling clock SCK successively transferred by the horizontal shift register 63 and distributed to the systems of the signal lines SIG of the display section 3 by the sampling latch circuit 64 and the line sequencing latch circuit 65. Further, the image data distributed in this manner are converted into analog signals by the digital to analog conversion sections 74 of the digital to analog conversion circuit 66. The horizontal driving circuit 4O outputs the driving signals to the odd-numbered pixels in the horizontal direction of the display section 3 while the horizontal driving circuit 4E outputs the driving signals to the even-numbered pixels in the horizontal direction of the display section 3. Consequently, in the liquid crystal display apparatus 1, the pixels of the corresponding systems are driven with the image data distributed to the systems by the data processing circuit 10 to display a color image.

### 3. Effects of the Embodiment

With the liquid crystal display apparatus of the present embodiment, image data are distributed into a plurality of systems such that the variation pattern relating to display of pseudo gradations is same in each of the systems, and a signal pattern representative of the variation pattern is generated to modulate the image data for each system. Consequently, peripheral circuits for the driving method based on the frame rate control can be formed integrally on the insulating substrate to assure reliable operation.

More particularly, the lowest order 1 bit of the image data is displayed with a pseudo gradation and the image data are distributed into two systems corresponding to odd-numbered pixels and even-numbered pixels in the horizontal direction of the display section such that the image data of the two systems are processed. Consequently, where the lowest order 1 bit of the image data is displayed in a pseudo gradation, reliable operation can be assured.

Further, since the image data are processed in two systems in this manner and the horizontal driving circuits for processing of the different systems are disposed on the upper side and the lower side of the display section, the wiring scheme between the display section 3 and the horizontal driving circuits can be simplified and the liquid crystal display apparatus can be formed in a frame narrowed as much.

[Other]

While, in the embodiment described above, the lowest order 1 bit of image data is represented in a pseudo gradation, the present invention is not limited to this but can be applied widely where various numbers of bits are represented in pseudo gradations.

Further, while, in the embodiment described above, peripheral circuits are formed integrally on a glass substrate, the present invention is not limited to this but can be applied widely where peripheral circuits are formed integrally on various insulating substrates.

Further,.while, in the embodiment described above, the present invention is applied to a liquid crystal display apparatus, the present invention is not limited to this but can be applied widely to various flat display apparatus such as a display apparatus which uses an organic EL element.

The present invention can be applied to a flat display apparatus and a driving method for a flat display apparatus, for example, to a liquid crystal display apparatus.

While a preferred embodiment of the present invention has been described using specific terms, such description is for illustrative purposes only, and it is to be understood that changes and variations may be made without departing from the spirit or scope of the following claims.

What is claimed is:

1. A flat display apparatus for displaying an image having a pseudo gradation by varying the gradation of each pixel with a variation pattern different from that of an adjacent pixel in a unit of a frame, comprising:
a display section having a plurality of pixels disposed in a matrix thereon;
a vertical driving circuit for successively selecting said pixels of said display section in a unit of a line;
a horizontal driving circuit for outputting a driving signal to said pixels of said display section in response to the selection of the pixels by said vertical driving circuit; and
a data processing circuit for processing image data and outputting resulting data to said horizontal driving circuit,
said data processing circuit including:
a serial to parallel conversion circuit for distributing the image data into a plurality of systems in response to the variation pattern of the gradation of the pixels such that the variation patterns of the gradations of the corresponding pixels in each system may be the same and outputting the image data of the systems;
a signal pattern generation circuit for generating a signal pattern representative of the variation pattern for each of the systems; and
a modulation circuit for adding, for each of the systems, in response to a logic value of a lower order side bit or bits of the image data relating to the display of the pseudo gradation, a logic value of the corresponding signal pattern to high order side bits and outputting the image data of each of the systems to said horizontal driving circuit.

2. The flat display apparatus according to claim 1, wherein the low order side bit relating to the display of the pseudo gradation is the lowest order bit of the image data, and said serial to parallel conversion circuit outputs the image data in two systems corresponding to odd-numbered pixels and even-numbered pixels in the horizontal direction of said display section.

3. The flat display apparatus according to claim 2, wherein said horizontal driving circuit includes a pair of driving circuits disposed on the upper side and the lower side of said display section for individually processing the image data of the two systems.

4. A driving method for a flat display apparatus wherein high order side bits of image data are modulated in response to a low order side bit or bits of the image data to produce modulation data and a plurality of pixels disposed in a matrix are driven with the modulation data such that an image having a pseudo gradation is displayed by varying the gradation of each of said pixels with a variation pattern different from that of an adjacent one of said pixels in a unit of a frame, comprising the steps of:
distributing the image data into a plurality of systems in response to the variation pattern of the gradation of the pixels such that the variation patterns of the gradations of the corresponding pixels in each system may be the same and outputting the image data of the systems; and
adding, for each of the systems, in response to a logic value of the lower order side bit or bits of the image data, a logic value of the signal pattern indicating the variation pattern to the high order side bits to modulate the image data of the systems to produce the modulation data.

5. A flat display apparatus for displaying an image having a pseudo gradation by varying the gradation of each pixel with a variation pattern different from that of an adjacent pixel in a unit of a frame, comprising:
a display section having a plurality of pixels disposed in a matrix thereon;
a vertical driving circuit for successively selecting said pixels of said display section in a unit of a line;
a horizontal driving circuit for outputting a driving signal to said display section in response to the selection of the pixels by said vertical driving circuit; and
a data processing circuit for processing image data and outputting resulting data to said horizontal driving circuit,
said data processing circuit including:
a signal pattern generation circuit for generating a signal pattern representative of the variation pattern; and
a modulation circuit for adding, in response to a logic value of a lower order side bit or bits of the image data relating to display of the pseudo gradation, a logic value of the corresponding signal pattern to high order side bits of the image data and outputting the image data to said horizontal driving circuit,
said modulation circuit including:
a low order side addition circuit for adding, to P low order side bits of the high order side bits, a logic value of the corresponding signal pattern in response to a logic value of the low order side bit or bits relating to the display of the pseudo gradation;
a high order side addition circuit for calculating a result of addition of Q high order side bits of the high order side bits except the P lower order side bits when a carry appears at the highest order bit of said low order side addition circuit; and
a selection circuit for selectively outputting the result of addition by said high order side addition circuit or the Q high order side bits in response to the carry, wherein
said modulation circuit outputs the image data which depend upon the addition result by said low order side addition circuit and the result of the selection of said selection circuit to said horizontal driving circuit.

6. The flat display apparatus according to claim 5, wherein the P low order side bits have a bit number greater than that of the Q high order side bits.

7. The flat display apparatus according to claim 5, wherein said data processing circuit includes a serial to parallel conversion circuit for distributing the image data into a plurality of systems in response to the variation pattern of the gradation of the pixels such that the variation patterns of the gradations of the corresponding pixels in each system may be the same and outputting the image data of the systems, and said modulation circuit and said signal pattern generation circuit are provided for each of the systems.
